(19) United States
(12) Patent Application Publication
(10) Pub. No.: US 2007/0120640 A1
(43) Pub. Date: May 31, 2007

(54) Plug with overload protection and a safety switch

(76) Inventor: Han-Ming Lee, Hsin Chu City (TW)

Correspondence Address: Han-Ming Lee, P.O.BOX 7-288, TAIPEI, TW

(21) Appl. No.: 11/287,098

(22) Filed: Nov. 28, 2005

(51) Int. Cl. H01H 61/00; H01H 71/16

(52) U.S. Cl. 337/37

(57) ABSTRACT

The present invention provides a plug with overload protection and a safety switch. It is comprised of an upper case, a bottom case, two conductive polar plates, two connective plates, two alloy plates, a safety switch, and a return spring. The main features are as follows: the end of one conductive polar plate is joined with an alloy plate by mortise and tenon joint, while the other alloy plate, located on the rear end of the said plate, is joined with the front end of the connective plate by mortise and tenon joint. Then it will become electric connected. Also, the protruding insulating plate that on the bottom of the upper safety switch is just located on the top of the gap between the two alloy plates. When the circuit is short-circuited or overheated due to overload, the two alloy plates will be expanded and outstretched relatively to allow the return spring in the other end of the switch to push the insulating plate into the gap between the two alloy plates to cut the circuit between them with one of the features of the present invention, called the safety switch, which is equipped with automatic circuit breaker protection for the sake of safety.

### BACKGROUND OF THE INVENTION

In this 21^{st} century of electronics, every electronic appliance, no matter it is used for household or industrial purpose, is closely related to people's daily life. However, no matter what kind of electronic appliance it is, all electronic appliances have to obtain power by plugging the plug into the socket Therefore, if the plug of the electronic appliance that goes to the socket of the extended cord is frequently plugged and unplugged, the contacts may have an increased risk of fire. The factors such as power surge, wrong supply voltage, and/or the electronic appliance itself is short-circuited or overloaded could easily cause a shock or fire. Nowadays, a technical breakthrough is urgently needed for plugs.

### SUMMARY OF THE INVENTION

The primary purpose of the present invention is to provide a plug with overload protection and a safety switch. It is comprised of an upper case, a bottom case, two conductive polar plates, two connective plates, two alloy plates, a safety switch and a return spring to provide unique features such as safety switch's automatic circuit breaker protection for the sake of safety.

The secondary purpose of the present invention is to provide a plug with overload protection and a safety switch. It indicates that the end of one conductive polar plate is joined with an alloy plate by mortise and tenon joint, while the other alloy plate, located on the rear end of the said plate, is joined with the front end of the connective plate by mortise and tenon joint. Then it will become electric connected.

Another purpose of the present invention is to provide a plug with overload protection and a safety switch. It indicates that the protruding insulating plate that on the bottom of the upper safety switch is just located on the top of the gap between the two alloy plates. When the circuit is short-circuited or overheated due to overload, the two alloy plates will be expanded and outstretched relatively to allow the return spring in the other end of the switch to push the insulating plate into the gap between the two alloy plates in order to cut the circuit between them by one of the features of the plug.

Another purpose of the present invention is to provide a plug with overload protection and a safety switch. Among them, the plate, which is in the relative joint location of the two alloy plates, is upward and outstretched and there are two protruding slide plate on it. When the power supply is normal, it allows users to manually push the protruding insulating, which is on the bottom of the safety switch, into the gap between the two alloy plates in order to cut the circuit between them with one of the features of the plug.

### BRIEF DESCRIPTION OF THE DRAWINGS

FIG. 1 is the illustration of a better example to practice the present invention.

FIG. 2 is the exploded diagram of the components of the present invention.

FIG. 3 is the diagram of the present invention that the alloy plates are expanded, outstretched relatively and separated.

FIG. 4 is the functional diagram of the present invention that the return spring pushes the insulating plate into the gap between the two alloy plates.

FIG. 5 is the functional diagram of the present invention that the insulating plate is being pushed on the slide plate to separate the two alloy plates.

### DELTAILED DESCRIPTION OF THE PREFERRED EMBODIMENT

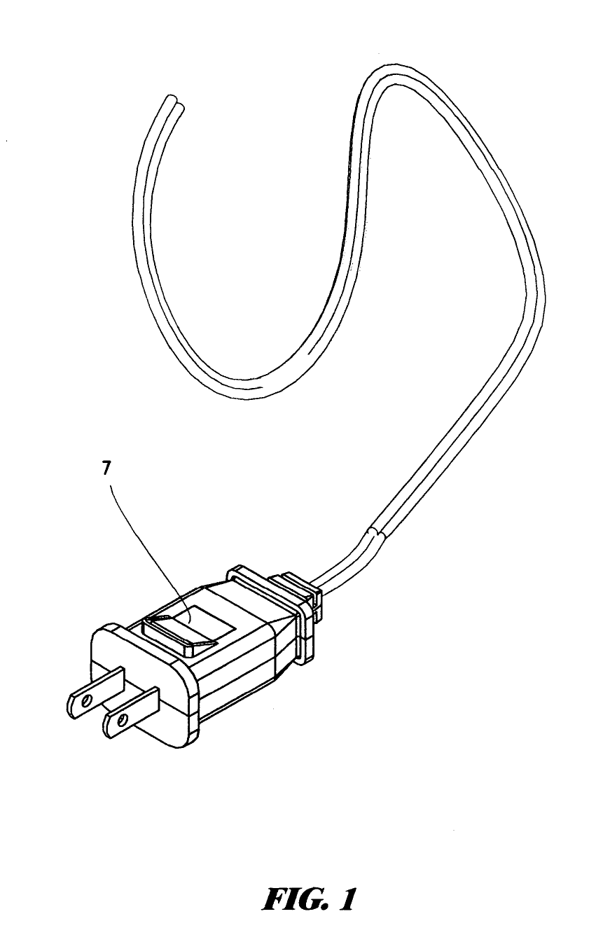

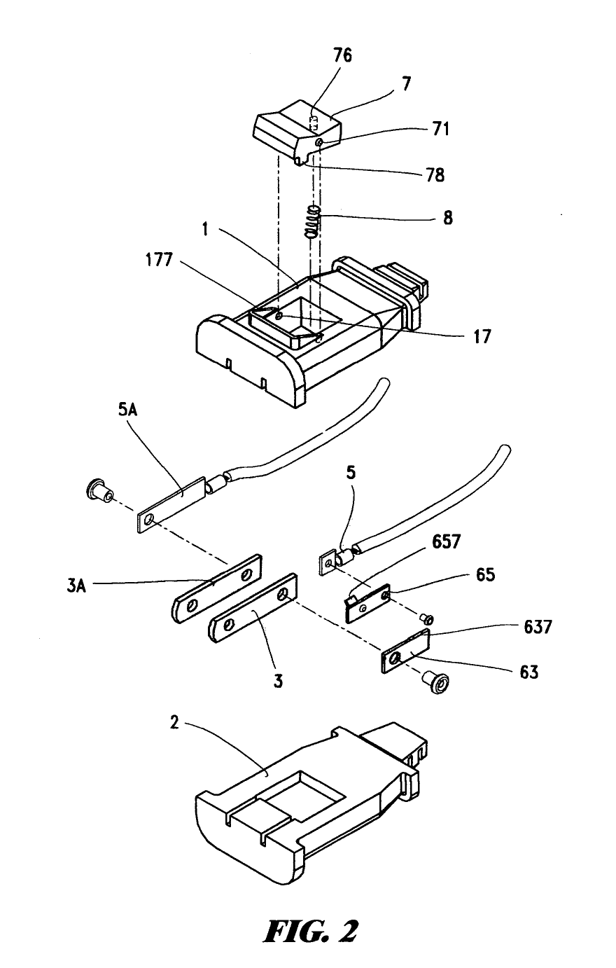

Please refer to FIG. 1 and FIG. 2. The present invention is a plug with overload protection and a safety switch. It is mainly comprised of an upper case 1, a bottom case 2, two conductive polar plates 3, 3A, two connective plates 5, 5A, two alloy plates 63, 65, a safety switch 7 and a return spring 8. The upper case I and bottom case 2 are the unassembled cases of prior art. The main feature is that there is a compartment 17 located on in the center of the upper case 1, with an arch-shape protection rim 177 surrounding it, and the relative orientation holes 171 in both sides of the compartment 17, which allows the orientation bolt 71 in both sides of the safety switch 7 to be screwed and fixed.

Among them, there is a protruding plate 76 located on the bottom front end of the safety switch. A return spring 8 is put into the protruding post 78, which is located on the bottom rear end of the said safety switch. A conductive polar plate 3 is placed between the upper case and the bottom case, and an alloy plate 63 is joined with the conductive polar plate 3 by mortise and tenon joint. The other alloy plate 65, located on the rear end of the said alloy plate, is joined with the front end of the connective plate 5. Both of the alloy plates 63, 65 are in the relative joint position and then become electric connected. There is a protruding and outstretched slide plates 637, 657 in the relative joint position of the two alloy plates respectively. The rear end of the connective plate 5A is joined with another conductive polar plate 3A by mortise and tenon joint while the rear ends of the two connective plates 5, 5A are connected to the power cord (positive pole and negative pole) to serve as one of the features of the structure of the present invention.

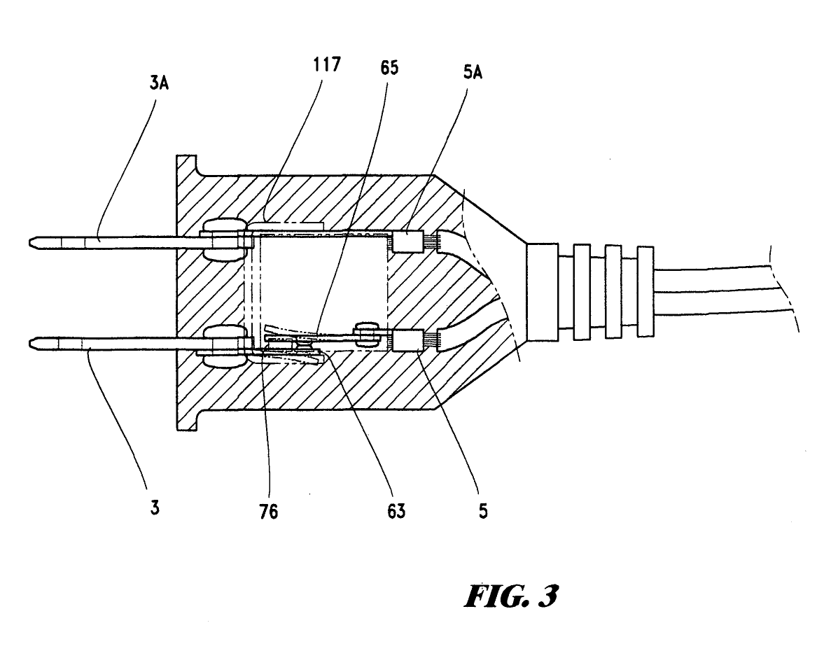

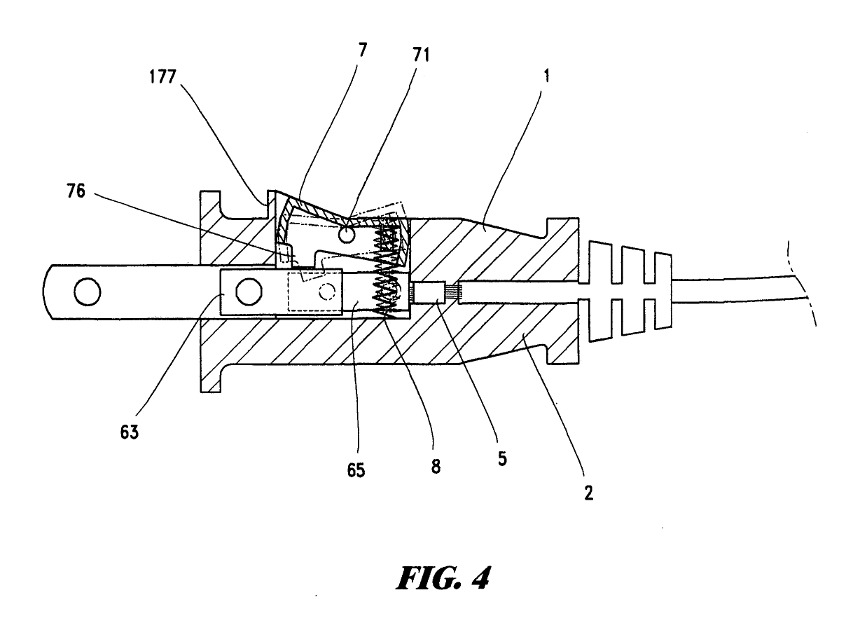

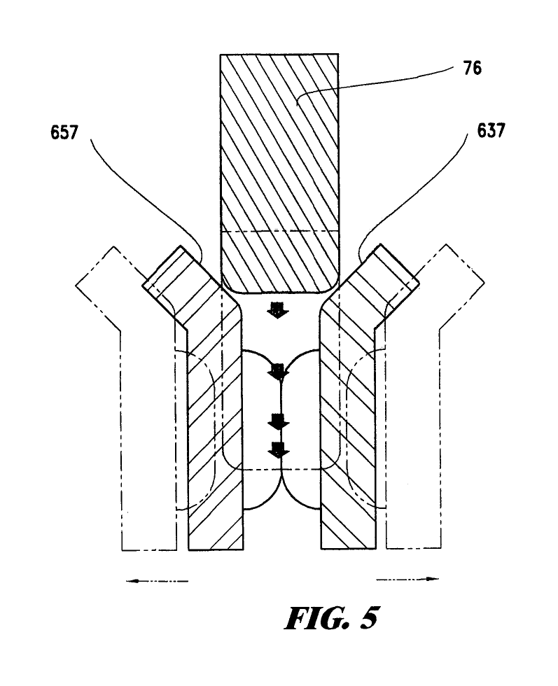

Please refer to FIG. 3 to FIG. 5 for the practice of the present invention. The protruding insulating plate 76, which is on the bottom of the safety switch on the top, is just located on the top of the two slide plates 637, 657 in the gap between the two alloy plates 63, 65. When the circuit is short-circuited or overheated due to overload, the two alloy plates will be expanded and outstretched relatively to allow the return spring in the other end of the switch to push the insulating plate into the gap between the two alloy plates to cut the circuit between them with one of the features of the present invention, called the safety switch, in order to match the industrial use value.

Among them, when the power supply is normal, the safety switch of the present invention allows users to manually push the protruding insulating, which is located on the bottom of the safety switch. Then the circuit is cat. The arch-shape protection rim 177, surrounding the compartment, is a foolproof safety mechanism that prevents the safety switch from collision-induced damages under normal power supply so as to provide the comprehensive safety protection to benefit the circuit and to serve as one of the features of the present invention.

It will be understood that each of the elements described above, or two or more together many also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in ant way from the spirit of the present invention.

What is claimed is:

1. A plug with overload protection and a safety switch. It is comprised of an upper case, a bottom case, two conductive polar plates, two connective plates, two alloy plates, a safety switch and a return spring. The main features are as follows:
There is a compartment in the center of the upper case with an arch-shape protection rim surrounding it, and the relative orientation holes in both sides of the said compartment, which allows the orientation bolt in both sides of the safety switch to be screwed and fixed. Among them, there is a protruding plate on the bottom front end of the safety switch. A return spring is put into the protruding post, which is located on the bottom rear end of the said safety switch. A conductive polar plate is located between the upper case and the bottom case, and an alloy plate is joined with the conductive polar plate by mortise and tenon joint. The other alloy plate, located on the rear end of the said alloy plate, is joined with the front end of the connective plate by mortise and tenon joint and becomes electric connected. The rear end of the connective plate is joined with another conductive polar plate by mortise and tenon joint while the rear end of the two connective plates is connected to the power cord (positive pole and negative pole).
By adopting the structure mentioned above, when the circuit is short-circuited or overheated due to overload, the two alloy plates will be expanded and outstretched relatively to allow the return spring in the other end of the switch to push the insulating plate into the gap between the two alloy plates to cut the circuit between them with one of the features of the present invention, called the safety switch, which is equipped with automatic circuit breaker protection for the sake of safety.

2. As mentioned in section 1 of the patent application claim, there is a wafer carrier equipped with multiple features. Among them, there are two protruding slide plates in the relative joint location of the two alloy plates that are upward and outstretched. It is designed to manually push the protruding insulating, which is located on the bottom of the safety switch, into the gap between the two alloy plates to cut the circuit between them.

3. As mentioned in section 1 of the patent application claim, there is a wafer carrier equipped with multiple features. Among them, the arch-shape protruding protection rim, surrounding the compartment, is a foolproof safety mechanism that prevents the safety switch from collision-induced damages under normal power supply.
